(19) United States
(12) Patent Application Publication
(10) Pub. No.: US 2011/0137772 A1
(43) Pub. Date: Jun. 9, 2011

(54) Devices, Systems and Methods for SLA-Based Billing

(75) Inventors: John Potts Davis, III, Marietta, GA (US); Justin Michael Anthony McNamara, Atlanta, GA (US); Jay Daryl Rector, Loganville, GA (US)

(73) Assignee: AT&T MOBILITY II LLC, Atlanta, GA (US)

(21) Appl. No.: 12/632,106

(22) Filed: Dec. 7, 2009

(51) Int. Cl. G06Q 10/00; H04M 11/00; H04W 24/00; G06Q 30/00; G06Q 50/00; G06F 17/30

(52) U.S. Cl. 705/34; 455/406; 455/423; 705/304; 707/770; 707/E17.032

(57) ABSTRACT

Devices, systems and methods are disclosed which relate to automatically detecting user dissatisfaction and billing a user accordingly. Systems for providing customer service to a user of a telecommunication network include a mobile communication device having logic for submitting a QoS complaint. A billing server on the telecommunications network retrieves a Service Level Agreement (SLA) for the user from a user account database. The billing server also communicates with a CDR database having CDRs associated with the SLAs. Some of the CDRs include QoS complaints from the user. A logic on the billing server references the CDRs. If the billing server determines that a user is not receiving the QoS that is defined in the SLA, then the billing server calculates a discount to apply to the relevant bill. If the billing server determines that the user is dissatisfied with the QoS they are receiving, when the QoS is consistent with the SLA, then the SLA is modified to increase the QoS, and the user is billed accordingly.

### BACKGROUND OF THE INVENTION

1. Field of the Invention

The present invention relates to telecommunication networks. More specifically, the present invention relates to adjusting parameters of a telecommunication network for improved customer service.

2. Background of the Invention

Communications devices, such as cellular phones, have become a common tool of everyday life. Cellular phones are no longer being used simply to place telephone calls. With the number of available features rapidly increasing, cellular phones are now used for storing addresses, keeping a calendar, reading e-mails, drafting documents, etc. These devices are small enough that they can be carried in a pocket or purse all day, allowing a user to stay in contact almost anywhere. Recent devices have become highly functional, providing applications useful to business professionals as well as the casual user.

The addition of these services uses the ability of mobile communication devices to transfer large amounts of data. Many wireless companies charge users according to a data rate. A user is charged more for a higher data rate than for a lower data rate. Wireless companies maintain a database of call data records (CDR) within the telecommunication network. Each CDR includes information concerning when a user terminates a connection, when a user initiates a connection, the type of connection, QoS, etc. Elements on the telecommunication network determine when a user terminates a connection by pressing an “END” key effectively, and when a connection terminates because of some other event, such as lost signal, etc. Generally, the network operator has a good idea of whether a user terminates connections on purpose, or there is some problem on the telecommunication network.

However, many users of telecommunication networks continue to call their wireless companies and complain about their dropped connections, low quality connections, etc. Today, these complaints are neutralized in a discount to the bill, based upon the detected dropped or low quality calls. However, this is usually performed once per billing cycle, or in response to a user's complaints. This requires additional steps, resulting in increased time and reduced efficiency, both for the network operator and for the user, as well as reduced user satisfaction and revenue per user.

What is needed in the art is a way to settle these complaints more efficiently, and relieving time for the user and the network operator.

### SUMMARY OF THE INVENTION

The above problems are solved by the disclosed devices, systems, and methods for automatically detecting user dissatisfaction and billing a user accordingly. Exemplary embodiments of the present invention include systems for providing customer service to a user of a telecommunication network, which include a mobile communication device having logic for submitting a QoS complaint. A billing server on the telecommunications network retrieves a Service Level Agreement (SLA) for the user from a user account database. The billing server also communicates with a CDR database having CDRs associated with the SLAs. Some of the CDRs include QoS complaints from the user. A logic on the billing server references the CDRs. If the billing server determines that a user is not receiving the QoS that is defined in the SLA, then the billing server calculates a discount to apply to the relevant bill. If the billing server determines that the user is dissatisfied with the QoS they are receiving, when the QoS is consistent with the SLA, then the SLA is modified to increase the QoS, and the user is billed accordingly.

Furthermore the billing server can recognize a trend in users not receiving the QoS defined in their SLAs. The billing server sorts CDRs having poor connections by location. If the billing server determines a location corresponding to poor connections, then the billing server issues an order to strengthen the signal at that location. Alternately, the billing server may notice that the location corresponds to poor connections, but only at a certain time. In this case, the billing server issues an order to strengthen the signal at that location at that time.

In one exemplary embodiment, the present invention is a system for providing customer service to a user of a telecommunication network. The system includes a mobile communication device on a telecommunications network, a complaint logic on the mobile communication device for submitting a QoS complaint including a complaint QoS, a time, and a location, a billing server on the telecommunications network, a user account database in communication with the billing server, the user account database having an SLA associated with the user, the SLA having a threshold QoS, a CDR database in communication with the billing server, the CDR database having a plurality of CDRs associated with the SLA, the plurality including a CDR having the QoS complaint, and a customer service logic on the billing server for referencing the plurality of CDRs, comparing the complaint QoS with the threshold QoS, and billing the user.

In another exemplary embodiment, the present invention is a method for providing customer service to a user of a telecommunication network, the user being associated with an SLA and providing a QoS complaint including a complaint QoS, a time, and a location. The method includes referencing a CDR database having a plurality of CDRs associated with the SLA, the plurality including a CDR having the QoS complaint, comparing the complaint QoS with the threshold QoS, the threshold QoS being associated with the SLA, and billing the user.

In yet another exemplary embodiment, the present invention is a method for discovering and improving poor locations in a telecommunication network, the telecommunication network including a plurality of users providing QoS complaints including a complaint QoS, a time, and a location. The method includes sorting a plurality of CDRs by location, the plurality including CDRs having QoS complaints, determining a location associated with poor connections, and strengthening the signal corresponding to the location.

### BRIEF DESCRIPTION OF THE DRAWINGS

FIG. 1 shows a system for automatically detecting user dissatisfaction and billing a user accordingly, according to an exemplary embodiment of the present invention.

FIG. 2 shows a method for providing customer service to a user of a telecommunication network, according to an exemplary embodiment of the present invention.

FIG. 3 shows a method for discovering and improving poor locations in a telecommunication network, according to an exemplary embodiment of the present invention.

FIGS. 4A and 4B show a mobile communication device for submitting a QoS complaint, according to an exemplary embodiment of the present invention.

FIG. 5 shows a QoS complaint submission application on a mobile communication device, according to an exemplary embodiment of the present invention.

### DETAILED DESCRIPTION OF THE INVENTION

Exemplary embodiments of the present invention include systems for providing customer service to a user of a telecommunication network, which include a mobile communication device having logic for submitting a QoS complaint. A billing server on the telecommunications network retrieves a Service Level Agreement (SLA) for the user from a user account database. The billing server also communicates with a CDR database having CDRs associated with the SLAs. Some of the CDRs include QoS complaints from the user. A logic on the billing server references the CDRs. If the billing server determines that a user is not receiving the QoS that is defined in the SLA, then the billing server calculates a discount to apply to the relevant bill. If the billing server determines that the user is dissatisfied with the QoS they are receiving, when the QoS is consistent with the SLA, then the SLA is modified to increase the QoS, and the user is billed accordingly.

Furthermore the billing server can recognize a trend in users not receiving the QoS defined in their SLAs. The billing server sorts CDRs having poor connections by location. If the billing server determines a location corresponding to poor connections, then the billing server issues an order to strengthen the signal at that location. Alternately, the billing server may notice that the location corresponds to poor connections, but only at a certain time. In this case, the billing server issues an order to strengthen the signal at that location at that time.

By utilizing exemplary embodiments of the present invention, a user will not have to call their network operator each month to try and settle charges based on their amount of dropped connections, low QoS, etc. Furthermore, users will pay an amount for data proportionate to the QoS they experience while using data. The network operator that operates the telecommunication network detects that a user has had twenty dropped connections this week. However, rather than the user calling the network operator, complaining, and asking the network operator for a partial refund for that billing cycle, the network operator recognizes the twenty dropped connections ahead of time and adjusts billing according to the quality of service that was provided. Additionally, if a user's home has poor coverage resulting in a user always struggling to get telephone calls from inside the home, then the network operator identifies the poor coverage based on a delivered QoS reported in the CDR. The network operator therefore knows that the user is having troubles, and correspondingly adjusts billing for the user. The network operator bills normally for a high QoS connection, but dynamically adjusts billing for a low QoS connection.

“Mobile communication device”, as used herein and throughout this disclosure, refers to any electronic device capable of wirelessly sending and receiving data. A mobile communication device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a telecommunication network, logic may be programmed on a server, or a complex of servers. A particular logic unit is not limited to a single logical location on the telecommunication network.

“Telecommunication network”, as used herein and throughout this disclosure, refers to a wireless network, a wireline network, or any network including a combination of wireless and wireline network elements. A telecommunication network can include broadband wide-area networks, local-area networks, and personal area networks. Communication across a telecommunication network is preferably packet-based; however, radio and frequency/amplitude modulations networks can enable communication between communication devices using appropriate analog-digital-analog converters and other elements. Examples of radio networks include cellular (GPRS, UMTS, TDMA, CDMA, etc.), Wi-Fi, BLUETOOTH® networks, etc., with communication being enabled by hardware elements called “transceivers.” Some mobile communication devices may have more than one transceiver, capable of communicating over different networks. For example, a cellular telephone can include a GPRS transceiver for communicating with a cellular base station, a Wi-Fi transceiver for communicating with a Wi-Fi network, and a positioning satellite receiver for receiving a signal from a positioning satellite. A telecommunication network typically includes a plurality of elements that host logic for performing tasks on the telecommunication network. In modern packet-based wide-area networks, servers may be placed at several logical points on the telecommunication network. Servers may further be in communication with databases and can enable communication devices to access the contents of a database. A server can span several network elements, including other servers in the telecommunication network.

“Quality of Service (QoS)”, as used herein and throughout this disclosure, refers to a set of quality requirements on the collective behavior of one or more objects or elements on a telecommunication network. QoS comprises requirements on all the aspects of a connection, such as service response time, loss, signal-to-noise ratio, cross-talk, echo, interrupts, frequency response, loudness levels, etc. QoS also comprises aspects of a connection relating to capacity and coverage of the telecommunication network, such as guaranteed maximum blocking probability and outage probability.

“Service Level Agreement (SLA)”, as used herein and throughout this disclosure, refers to a negotiated agreement between a user of a telecommunication network and a network operator. The SLA records a common understanding about services, priorities, responsibilities, guarantees, and warranties. Included in the SLA is a “threshold QoS” which sets a guaranteed QoS for the user. The threshold QoS includes different elements for setting minimums on data bitrate, voice call quality, etc. In exemplary embodiments, the SLA also includes a threshold number of dropped connections.

“Call Data Record (CDR)”, as used herein and throughout this disclosure, refers to a record produced by a connection across a telecommunication network containing details of a call that passed through it. Types of connections include voice calls, data connections, video conferences, etc. The CDR identifies the element initiating the connection, the element responding to the connection, network elements traversed, the date and time the connection was initiated, the duration of the connection, the type of connection, the user billed for the connection, the result of the connection (answered, busy, voicemail, etc.), the means by which the connection ended (hang-up, lost signal, etc.), any fault condition encountered, etc.

“Poor connection”, as used herein and throughout this disclosure, refers to a connection that does not meet the requirements of a threshold QoS or that results in a dropped connection.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

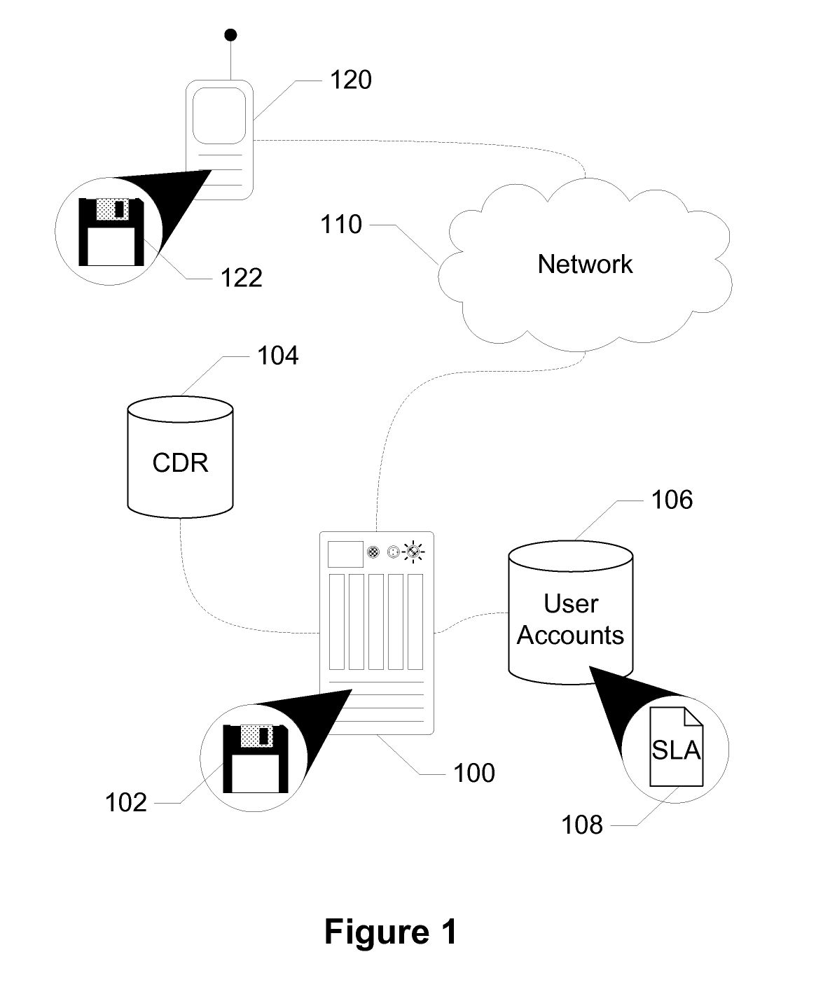

FIG. 1 shows a system for automatically detecting user dissatisfaction and billing a user accordingly, according to an exemplary embodiment of the present invention. The system includes a mobile communication device 120 capable of communicating across a telecommunications network 110. Mobile communication device 120 includes a QoS complaint logic 122 that provides a user with the ability to electronically submit a complaint about their QoS. The QoS complaint includes a complaint QoS, a time, and a geographical location, or simply “location.” A billing server 100 is also on telecommunications network 110, and contains a customer service logic 102. Billing server 100 communicates with a user account database 106 which has an SLA 108 associated with the user. Billing server 100 also communicates with a CDR database 104 which has a plurality of CDRs associated with SLA 108. At least one of the CDRs in CDR database 104 includes the QoS complaint submitted by complaint logic 122. The dotted lines indicate that communication can be wired, wireless, or any combination thereof between the network elements.

The user can experience a poor connection, a dropped call, or is simply be dissatisfied with the level of service provided. The user submits a QoS complaint about the service immediately after the aggrieving connection. The QoS complaint includes the time, the location, and information concerning the quality, for instance, a complaint QoS. Furthermore, a CDR is generated for every connection on telecommunications network 110. A submitted complaint is added to the CDR corresponding to the aggrieving connection. The CDR additionally includes information about the QoS. Before delivering a bill to the user, customer service logic 102 references CDR database 104. Customer service logic 102 searches for CDRs that correspond to that user, and finds the submitted QoS complaint. Customer service logic 102 then compares the complaint QoS with the threshold QoS found in SLA 108. If the threshold QoS is less than the complaint QoS, e.g., if the connection was at a level of quality that fell above the threshold level, then the user is determined to be dissatisfied with their contracted QoS. In response, customer service logic 102 modifies the contracted QoS by increasing the threshold QoS in SLA 108. The user can be correspondingly billed for the increase. If the threshold QoS is greater than the complaint QoS, then it is determined that the user is not receiving their contracted QoS. Billing server 100 discounts the user's bill to make up for the poor connections.

In other embodiments of the present invention, the logic employed to carry out these functions may reside on other network elements. For instance the complaint logic may reside on an application server on the telecommunication network where it is accessed by the mobile communication device through a web portal. The billing server may be a combination of servers in order to distribute the work load. The user account and CDR databases may reside on other servers in communication with the billing server. The user preferably submits a complaint immediately after the aggrieved connection for ease of associating the complaint with the correct CDR. However, the user may make the complaint at a later time and date provided the user can provide enough details about the aggrieved connection to make an association with the proper CDR.

Embodiments of the present invention include billing a user a varied amount based on the SLA, or connection quality. Factors that affect quality include a percentage of dropped connections, average QoS, etc. Depending on where the user is in the cellular environment, the user experiences different data rates back and forth to user's mobile communications device. The CDRs are used by a customer service logic to identify those rates, and the user's bill is adjusted dynamically.

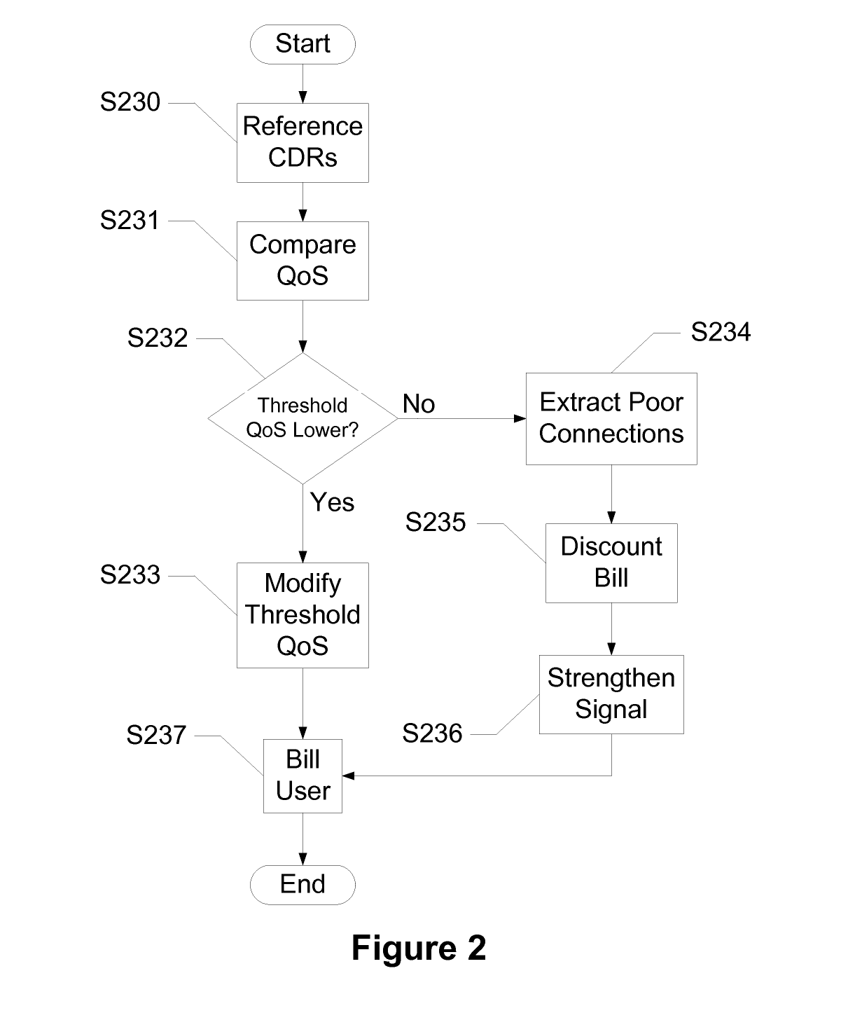

FIG. 2 shows a method for providing customer service to a user of a telecommunication network, according to an exemplary embodiment of the present invention. This embodiment is presented from the point of view of a billing server or a billing system. Before billing a user for a service, the billing server references a CDR database having a plurality of CDRs S230. The billing server searches for CDRs corresponding to the user about to be billed. One of these CDRs includes a QoS complaint, including a complaint QoS. The user may not know whether the complaint QoS is lower or higher than the threshold QoS, but in either case the user desires a higher QoS than what was delivered. Therefore, the complaint QoS and the threshold QoS are compared S231 to determine whether the threshold QoS is higher or lower than the complaint QoS S232. If the threshold QoS is lower than the complaint QoS, then it is determined that the user is dissatisfied with their contracted threshold QoS. The threshold QoS is then increased so that the user experiences a higher QoS during subsequent connections S233. The user is billed an increased amount for this increase in threshold QoS. If the complaint QoS is lower than the threshold QoS, then it is determined that the user is not receiving their contracted threshold QoS. The billing server extracts a number of poor connections from the CDRs associated with the user S234. The user's bill is discounted an amount based on the number of poor connections S235. In this embodiment, the billing server further determines that the poor connections occur in a similar location. An order is issued to strengthen the signal at that location S236. Once these calculations have been made, the user's bill is updated S237.

Though this embodiment of the method is performed by a billing server, other servers or network elements may work in tandem with the billing server to accomplish the method. Furthermore each task of the method may be assigned to a different network element, each network element being suited to perform the task assigned. For instance, a database server may be more suited to referencing the CDR database, compiling a list of CDRs associated with the user, and calculating a number of poor connections. Determining whether a connection is poor or not may require looking at several aspects of the connection and its QoS.

Exemplary embodiments of the present invention analyze CDRs, user complaints, and other call logs to determine a number of dropped connections or poor connections a user has experienced before billing the user. Also included in the analysis is the average QoS. When a user is connected, the QoS will change with the location. Billing is based on whether a user receives a high QoS or low QoS. Furthermore, the telecommunication network can use location based services to record or “tag” locations with dropped connections. If a location is associated with a high number of dropped connections, then the company can use that information to strengthen the signal there. If the user's mobile communication device includes a positioning device, such as GPS, then the telecommunication network can receive a location determined by the positioning device of the mobile communication device.

When a connection is dropped, a network element performs a location dip to the mobile communication device to determine exactly where the mobile communications device is at the time the connection was dropped. If it is determined that a location is consistently associated with dropped connections, then an order is issued to strengthen the signal at that location.

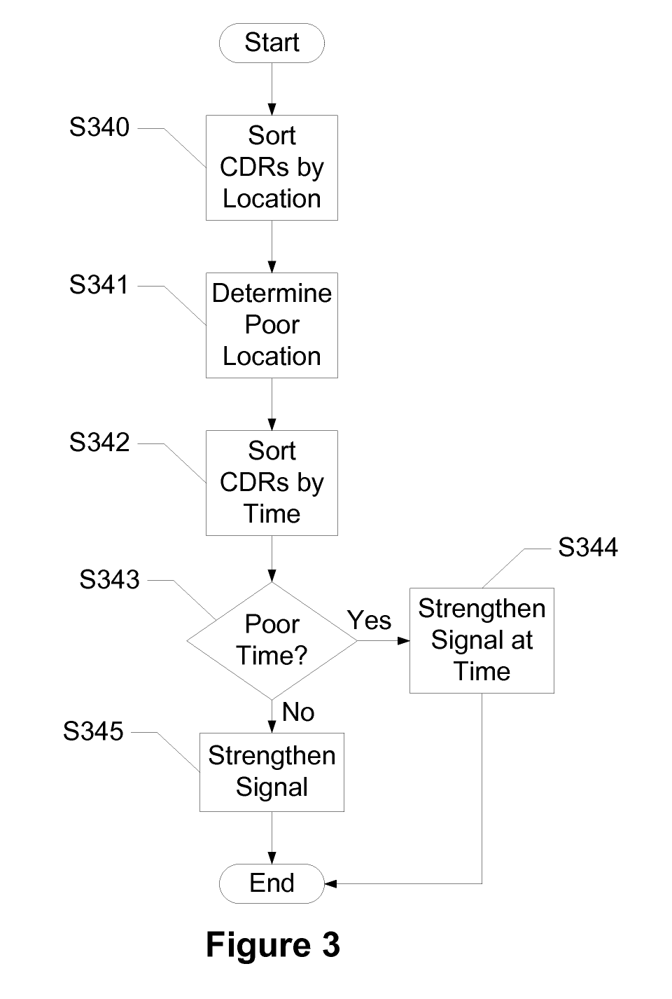

FIG. 3 shows a method for discovering and improving poor locations in a telecommunication network, according to an exemplary embodiment of the present invention. In order to provide better service for the users of a telecommunications network, a network operator can find locations having a weak signal that results in connections having a lower QoS. These poor locations may have underpowered antennas, a high amount of interference, an excess of physical barriers, etc. In order to find these poor locations, CDRs in the CDR database are sorted by location S340. Once the CDRs are sorted into groups by location, the QoS for each CDR in each location group is examined. If a location group consistently has a low QoS, then the location group is associated with a poor location S341. However, sometimes the location is not always associated with a low QoS, but only at certain times. For instance, a location may be in a mall which is crowded on the weekends, but empty at other times. A sports arena or amphitheater may be packed with tens of thousands of people for a couple hours, but empty at all other times. For this reason the analysis does not end simply with the location. The CDRs for each poor location are sorted by time S342. If there is a certain time or range of time in which the QoS is consistently low, and in which the QoS is not necessarily low at other times, then the location is associated with a poor time S343. If it is determined that the location has a poor time, then an order is issued to strengthen the signal at the location at the poor time S344. If it is determined that the location is simply a poor location, or is associated with a low QoS at all times, then an order is issued to strengthen the signal for that location at all times S345.

This method is performed by any of a number of network elements including the billing server, a combination of servers, etc. A location may be a large location or a small location. For instance, a location may be associated with an antenna, a base transceiver station, a base station subsystem, a plurality of base station subsystems, a mobile switching center, a geo-fence, a physical feature such as a valley, etc. Once an order is issued to strengthen the signal an analysis may be made to determine the best way to improve the signal, such as Transmission Power Control (TPC), adjusting a maximum number of channels allotted, eliminating physical barriers, etc. For instance, a location associated with underpowered antennas may require more power, but a high amount of interference may require clearing of foliage or adding new antennas or relays strategically placed around the interference. There are many possible techniques to improve the signal in a location that will become apparent to those having ordinary skill in the art upon reading this disclosure. Though many techniques are beyond the capability of a server on a network, these techniques can still be performed by the network operator, and thus are within the scope of this disclosure.

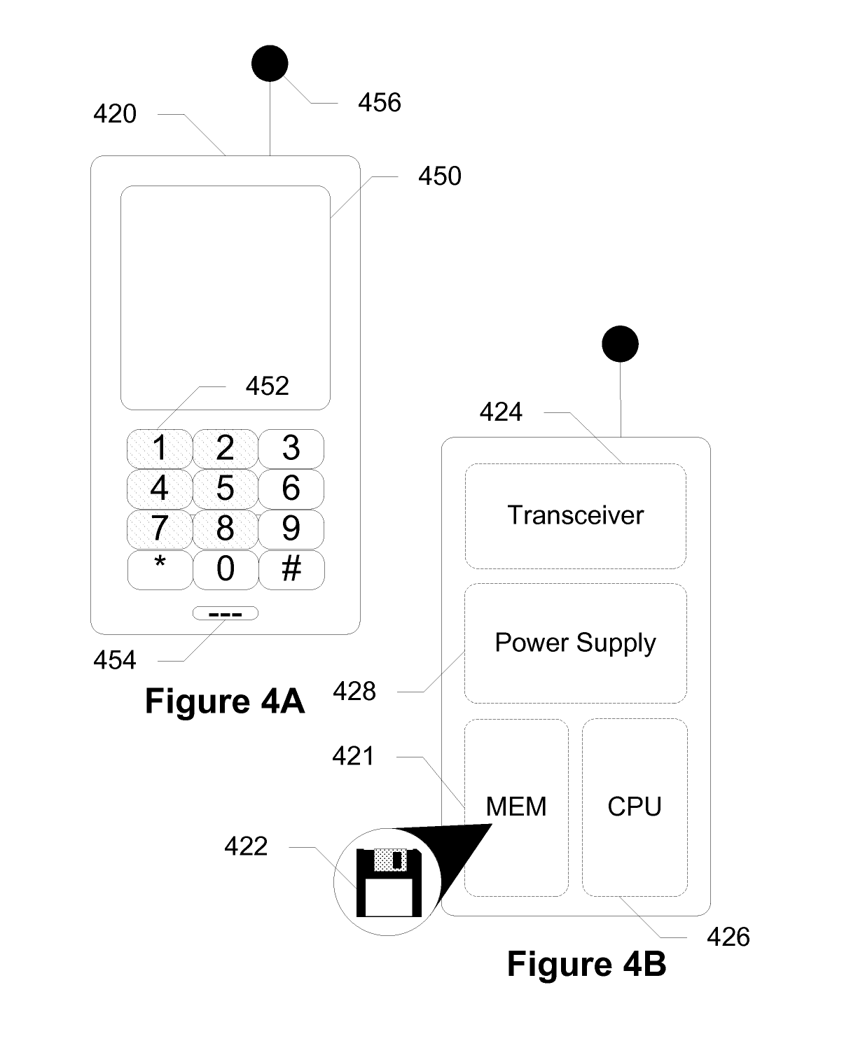

FIG. 4 shows a mobile communication device 420 for submitting a QoS complaint, according to an exemplary embodiment of the present invention. Mobile communication device 420 includes internal and external components.

FIG. 4A shows the external components of mobile communication device 420, according to an exemplary embodiment of the present invention. The external components of mobile communication device 420 include a display 450, a keypad 452, a microphone 454, and an antenna 456. Display 450 is a liquid crystal display (LCD) and is used for visual output from mobile communication device 420. Keypad 452 is a matrix of independently movable buttons which serve as tactile input for mobile communication device 420. Microphone 454 serves as voice input for voice calls placed by mobile communication device 420. Antenna 456 produces and receives electromagnetic signals that enable mobile communication device 420 to communicate wirelessly with other electronic devices.

The display may be an LED screen or any other type of electronic display. A touchscreen may be used as the display and tactile input. In these embodiments of the mobile communication device, a keypad is not necessary but can complement the touchscreen. In other embodiments the mobile communication device may take a completely different form, such as a laptop computer, PDA, netbook, etc.

FIG. 4B shows the internal components of mobile communication device 420, according to an exemplary embodiment of the present invention. The internal components of mobile communication device 420 include a memory 421 which has a complaint logic 422, a transceiver 424, a processor (CPU) 426, and a power supply 428. Memory 421 holds logic to be processed by processor 426 such as operating systems, applications, etc. Complaint logic 422 contains an application for a user to submit a complaint to the telecommunication network. Transceiver 424 receives encoded signals from the antenna and decodes them into a format usable by processor 426. Transceiver 424 also encodes data from processor 426 before sending it to the antenna. The memory, transceiver, and all of the external elements of mobile communication device 420 are in communication with processor 426. Processor 426 receives data and issues commands based on logic stored in memory 421. Finally, power supply 428 delivers power to each of the internal and external components of mobile communication device 420.

In further embodiments, the mobile communication device features a global positioning system (GPS) unit. This allows the mobile communication device to determine its position on a global scale. Logic on the memory can format the position in a number of ways such as a set of coordinates, an intersection, a city, a county, a state, a country, etc. Elements on the telecommunication network can request the position from the mobile communication device, i.e. a “location dip.” For instance, when accepting a complaint from the mobile communication device, an element on the telecommunication network may record a location along with the complaint. Therefore, the element requests a location from the mobile communication device at the reception of the complaint. Other embodiments of the mobile communication device feature an accelerometer. An accelerometer is another type of input based on movements and motion of the mobile communication device itself. For instance tilting the mobile communication device at an angle can input one command while tilting the mobile communication device at a different angle can input another command. Many embodiments of the mobile communication device also contain a SIM card or its equivalent. A SIM card may hold user identification information which is necessary for communication on the telecommunication network. SIM cards may also hold contact information, personal information, etc.

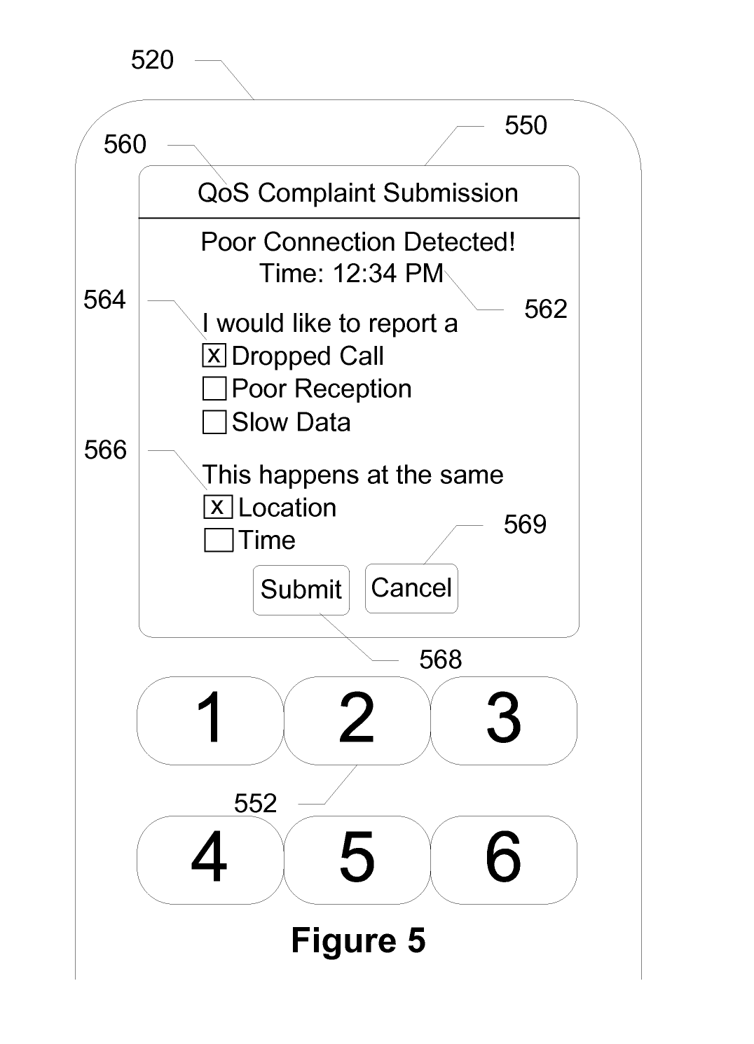

FIG. 5 shows a QoS complaint submission application on a mobile communication device 520, according to an exemplary embodiment of the present invention. QoS complaint submission application 560 is shown on the display of mobile communication device. Keypad 552 is used to select and enter options within QoS complaint submission application 560. In this embodiment, QoS complaint submission application 560 is activated as a result of the detection of a poor connection. Ideally, the poor connection happened within a short time before the QoS complaint, however, the user may input additional details for bolstering later-generated QoS complaints. The time of the connection 562 is referenced along with some options for the user to select in aiding the customer service process. The poor connection may have been detected by one of several aspects of the QoS. Therefore, to ensure the correct assessment has been made, the user is asked to report a more specific grievance 564. In this case, the user is reporting a dropped call. The user is also inquired about the frequency of poor connections 566. The user can specify whether this happens at the same location, at the same time, or both. Finally, the user can submit the complaint to the telecommunication network by selecting the Submit button 568. However, the user can also choose not to submit the complaint by selecting the Cancel button 569.

There are many alternate embodiments of the QoS complaint submission application. The QoS complaint submission application may be executed by the user at any time to submit a complaint. It may be beneficial to the network operator for the user to specify the time and location of the poor connection in order to associate the QoS complaint with the proper CDR. Other embodiments feature more detailed options and selections to better improve the customer service. A comment box is included in some embodiments where a user can input whatever text the user feels necessary to complete the overall complaint, to help the network operator understand the nature of the grievance, etc. These and other embodiments of the QoS complaint submission application will become apparent to those having skill in the art upon reading this disclosure.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for providing customer service to a user of a telecommunication network, the system comprising:
a mobile communication device on a telecommunications network;
a complaint logic on the mobile communication device for submitting a Quality of Service (QoS) complaint including a complaint QoS, a time, and a location;
a billing server on the telecommunications network;
a user account database in communication with the billing server, the user account database having a Service Level Agreement (SLA) associated with the user, the SLA having a threshold QoS;
a Call Detail Record (CDR) database in communication with the billing server, the CDR database having a plurality of CDRs associated with the SLA, the plurality of CDRs including a CDR having the QoS complaint; and
a customer service logic on the billing server for
retrieving the plurality of CDRs,
comparing the complaint QoS with the threshold QoS, and
billing the user.

2. The system in claim 1, wherein the customer service logic:
determines the threshold QoS to be lower than the complaint QoS;
modifies the threshold QoS to exceed the complaint QoS, and
bills the user for the modification to the threshold QoS.

3. The system in claim 1, wherein the customer service logic:
determines the threshold QoS to be higher than the complaint QoS;
extracts a number of poor connections from the plurality of CDRs, and
discounts a bill proportional to the number of poor connections, the bill corresponding to the SLA.

4. The system in claim 3, wherein the customer service logic strengthens the signal corresponding to the location.

5. The system in claim 1, wherein the customer service logic associates the QoS complaint with a CDR.

6. The system in claim 1, wherein the customer service logic requests a location from the mobile communication device upon receiving a QoS complaint.

7. The system in claim 1, wherein the mobile communication device includes a GPS unit.

8. A method for providing customer service to a user of a telecommunication network, the user being associated with an SLA, the method comprising:
receiving a QoS complaint from the user, the QoS complaint including a complaint QoS, a time, and a location;
retrieving a CDR database having a plurality of CDRs associated with the SLA, the plurality including a CDR having the QoS complaint;
comparing the complaint QoS with a threshold QoS associated with the SLA; and
billing the user based on a difference between the complaint QoS and the threshold QoS.

9. The method in claim 8, further comprising:
determining the threshold QoS to be lower than the complaint QoS;
modifying the threshold QoS to exceed the complaint QoS, and
billing the user for the modification to the threshold QoS.

10. The method in claim 8, further comprising:
determining the threshold QoS to be higher than the complaint QoS;
extracting a number of poor connections from the plurality of CDRs, and
discounting a bill proportional to the number of poor connections, the bill corresponding to the SLA.

11. The method in clam 10, further comprising strengthening a signal corresponding to the location.

12. The method in clam 8, further comprising:
receiving a QoS complaint; and
associating the QoS complaint with a CDR.

13. The method in claim 8, wherein the discounting further comprises discounting an amount proportional to the number of poor connections exceeding a threshold number of poor connections in the SLA from the bill corresponding to the user account.

14. The method in claim 8, further comprising extracting an average data rate from the plurality of CDRs corresponding to the user account.

15. The method in claim 14, further comprising charging an amount proportional to the average data rate to the user account.

16. A method for discovering and improving poor locations in a telecommunication network, the method comprising:
receiving a plurality of QoS complaints from a corresponding plurality of users of the telecommunication network, wherein each QoS complaint includes a complaint QoS, a time, and a location;
associating the plurality of QoS complaints with a plurality of CDRs;
sorting the plurality of CDRs by location;
determining a location associated with poor connections; and
strengthening the signal corresponding to the location.

17. The method in claim 16, further comprising
sorting a plurality of CDRs by time;
determining a time associated with poor connections at the location; and
strengthening the signal corresponding to the time and location.

18. The method in claim 16, wherein strengthening the signal includes delivering more power to an antenna at the location.

19. The method in claim 16, wherein strengthening the signal includes clearing foliage at the location.

20. The method in claim 16, wherein the strengthening the signal includes adding one of an antenna and a relay to the location.
